(19) United States
(12) Patent Application Publication
(10) Pub. No.: US 2024/0204842 A1
(43) Pub. Date: Jun. 20, 2024

(54) CHANNEL STATE FEEDBACK REPORTING DURING BEAM REFINEMENT

(71) Applicant: QUALCOMM Incorporated, San Diego, CA (US)

(72) Inventors: Raj Kumar Nattha, San Diego, CA (US); Yong Li, San Diego, CA (US); Kang Gao, San Diego, CA (US); Suyash Nachiket Sule, San Diego, CA (US); Raghu Narayan Challa, San Diego, CA (US); Jyothi Kiran Vattikonda, San Diego, CA (US); Fernando Alonso Macias, San Diego, CA (US); Vijay Balasubramanian, San Diego, CA (US)

(21) Appl. No.: 18/083,266

(22) Filed: Dec. 16, 2022

(51) Int. Cl. H04B 7/06; H04W 24/08

(52) U.S. Cl. CPC H04B 7/0626; H04W 24/08

(57) ABSTRACT

Methods, systems, and devices for wireless communications are described. A user equipment (UE) may perform beam refinement procedures for a first set of beams and a second set of beams. The first set of beams corresponds to a first set of synchronization signal blocks (SSBs) of a serving cell and the second set of beams corresponds to a second set of SSBs of the serving cell. The UE may transmit a message indicating channel state feedback (CSF) including either a first power metric for the first set of SSBs or both the first power metric and a second power metric for the second set of SSBs. The power metric(s) included in the CSF may be based on a first refinement status for the first set of SSBs as well as a second refinement status for the second set of SSBs or the second power metric satisfying a threshold.

### FIELD OF TECHNOLOGY

The following relates to wireless communications, including channel state feedback (CSF) reporting during beam refinement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, beam switching may be performed using measurements performed by a UE. In some examples, however, different measurements may be performed using different beam widths (e.g., due to ongoing beam refinement), which may result in varying measurement results. As such, beam switching based on such measurement results may sometimes cause increased latency, as well as unnecessary or delayed beam switches.

### SUMMARY

The described techniques relate to improved methods, systems, devices, and apparatuses that support channel state feedback (CSF) reporting during beam refinement. Generally, the described techniques provide for a user equipment (UE) to use a beam refinement status to determine whether to report a reference signal received power (RSRP) measurement of neighboring synchronization signal blocks (SSBs) to a network entity. For example, the UE may report the RSRP measurement of neighboring SSBs if a beam refinement status of the corresponding beams for the neighboring SSBs, and a beam refinement status of the corresponding beams for serving SSBs, have reached a certain refinement status. Alternatively, the RSRP measurement of the neighboring SSBs may be reported if the serving beams have achieved the refinement status and the RSRP measurement of the neighboring SSBs satisfies a threshold RSRP. As such, controls and rules may be used to determine when neighboring SSBs are reported as part of the CSF reporting during ongoing beam refinement, which may prevent or avoid early beam switching and late beam switching, and further preserve communications efficiency for the UE and the network entity.

A method for wireless communication at a UE is described. The method may include performing respective beam refinement procedures for a first set of directional beams and a second set of directional beams, the first set of directional beams corresponding to a first set of SSBs of a serving cell and the second set of directional beams corresponding to a second set of SSBs of the serving cell, where a first refinement status for the first set of SSBs and a second refinement status for the second set of SSBs are based on the respective beam refinement procedures, performing measurements of the first set of SSBs and the second set of SSBs, where a first power metric for the first set of SSBs and a second power metric for the second set of SSBs are based on the measurements, and transmitting a message indicating CSF including the first power metric or both the first power metric and the second power metric, where the CSF includes both the first power metric and the second power metric based on the first refinement status and the second refinement status or based on the second power metric satisfying a threshold.

An apparatus for wireless communication at a UE is described. The apparatus may include a processor, memory coupled with the processor, and instructions stored in the memory. The instructions may be executable by the processor to cause the apparatus to perform respective beam refinement procedures for a first set of directional beams and a second set of directional beams, the first set of directional beams corresponding to a first set of SSBs of a serving cell and the second set of directional beams corresponding to a second set of SSBs of the serving cell, where a first refinement status for the first set of SSBs and a second refinement status for the second set of SSBs are based on the respective beam refinement procedures, perform measurements of the first set of SSBs and the second set of SSBs, where a first power metric for the first set of SSBs and a second power metric for the second set of SSBs are based on the measurements, and transmit a message indicating CSF including the first power metric or both the first power metric and the second power metric, where the CSF includes both the first power metric and the second power metric based on the first refinement status and the second refinement status or based on the second power metric satisfying a threshold.

Another apparatus for wireless communication at a UE is described. The apparatus may include means for performing respective beam refinement procedures for a first set of directional beams and a second set of directional beams, the first set of directional beams corresponding to a first set of SSBs of a serving cell and the second set of directional beams corresponding to a second set of SSBs of the serving cell, where a first refinement status for the first set of SSBs and a second refinement status for the second set of SSBs are based on the respective beam refinement procedures, means for performing measurements of the first set of SSBs and the second set of SSBs, where a first power metric for the first set of SSBs and a second power metric for the second set of SSBs are based on the measurements, and means for transmitting a message indicating CSF including the first power metric or both the first power metric and the second power metric, where the CSF includes both the first power metric and the second power metric based on the first refinement status and the second refinement status or based on the second power metric satisfying a threshold.

A non-transitory computer-readable medium storing code for wireless communication at a UE is described. The code may include instructions executable by a processor to perform respective beam refinement procedures for a first set of directional beams and a second set of directional beams, the first set of directional beams corresponding to a first set of SSBs of a serving cell and the second set of directional beams corresponding to a second set of SSBs of the serving cell, where a first refinement status for the first set of SSBs and a second refinement status for the second set of SSBs are based on the respective beam refinement procedures, perform measurements of the first set of SSBs and the second set of SSBs, where a first power metric for the first set of SSBs and a second power metric for the second set of SSBs are based on the measurements, and transmit a message indicating CSF including the first power metric or both the first power metric and the second power metric, where the CSF includes both the first power metric and the second power metric based on the first refinement status and the second refinement status or based on the second power metric satisfying a threshold.

Some examples of the method, apparatuses, and non-transitory computer-readable medium described herein may further include operations, features, means, or instructions for determining that a first readiness indicator for the first set of SSBs may be true based on the first refinement status for the first set of SSBs and determining that a second readiness indicator for the second set of SSBs may be true based on the second refinement status for the second set of SSBs, where the CSF includes both the first power metric and the second power metric based on the first readiness indicator and the second readiness indicator being true.

In some examples of the method, apparatuses, and non-transitory computer-readable medium described herein, the first readiness indicator may be true based on the first refinement status for the first set of SSBs including a refinement concluded status and the second readiness indicator may be true based on the second refinement status for the second set of SSBs including the refinement concluded status.

In some examples of the method, apparatuses, and non-transitory computer-readable medium described herein, the refinement concluded status may be associated with a refinement failure status, or a refinement timeout status, or a refinement success status.

Some examples of the method, apparatuses, and non-transitory computer-readable medium described herein may further include operations, features, means, or instructions for determining that a first readiness indicator for the first set of SSBs may be true based on the first refinement status for the first set of SSBs and determining that the second power metric satisfies the threshold, where the CSF includes both the first power metric and the second power metric based on the first readiness indicator for the first set of SSBs being true and the second power metric satisfying the threshold.

In some examples of the method, apparatuses, and non-transitory computer-readable medium described herein, the threshold includes a sum of the first power metric and a hysteresis value.

Some examples of the method, apparatuses, and non-transitory computer-readable medium described herein may further include operations, features, means, or instructions for generating the hysteresis value based on whether CSF for the second set of SSBs may have been previously reported.

Some examples of the method, apparatuses, and non-transitory computer-readable medium described herein may further include operations, features, means, or instructions for decreasing the hysteresis value based on previously reporting the CSF for the second set of SSBs.

Some examples of the method, apparatuses, and non-transitory computer-readable medium described herein may further include operations, features, means, or instructions for increasing the hysteresis value based on the CSF for the second set of SSBs being excluded from previous reporting.

Some examples of the method, apparatuses, and non-transitory computer-readable medium described herein may further include operations, features, means, or instructions for receiving a control message indicating a configuration for performing the measurements of the first set of SSBs and the second set of SSBs, where the configuration indicates a first quantity of measurement occasions that satisfy a threshold quantity of measurement occasions, the first quantity of measurement occasions being based on the UE operating in a discontinuous reception mode and the first refinement status or the second refinement status, or both.

Some examples of the method, apparatuses, and non-transitory computer-readable medium described herein may further include operations, features, means, or instructions for determining that a readiness indicator for the second set of SSBs may be false based on the second refinement status and determining that the second power metric fails to satisfy the threshold, where the CSF includes the first power metric based on the readiness indicator for the second set of SSBs being false and the second power metric failing to satisfy the threshold.

In some examples of the method, apparatuses, and non-transitory computer-readable medium described herein, the first refinement status or the second refinement status, or both, includes an in-progress refinement status based on one or more directional beams being at a beam level that may be less than a threshold beam level.

In some examples of the method, apparatuses, and non-transitory computer-readable medium described herein, the first refinement status or the second refinement status, or both, includes a refinement failure status based on a failure of a set of multiple attempts to refine at least one directional beam to a threshold beam level.

In some examples of the method, apparatuses, and non-transitory computer-readable medium described herein, the first refinement status or the second refinement status, or both, includes a refinement timeout status based on duration for refining at least one directional beam exceeding a threshold duration.

In some examples of the method, apparatuses, and non-transitory computer-readable medium described herein, the first refinement status or the second refinement status, or both, includes a refinement success status based on refining one or more directional beams to a threshold beam level.

In some examples of the method, apparatuses, and non-transitory computer-readable medium described herein, the first power metric includes a first RSRP and the second power metric includes a second RSRP.

In some examples of the method, apparatuses, and non-transitory computer-readable medium described herein, the first set of SSBs includes a set of serving SSBs and the second set of SSBs includes a set of neighboring SSBs.

### BRIEF DESCRIPTION OF THE DRAWINGS

FIG. 1 illustrates an example of a wireless communications system that supports channel state feedback (CSF) reporting during beam refinement in accordance with one or more aspects of the present disclosure.

FIG. 2 illustrates an example of a wireless communications system that supports CSF reporting during beam refinement in accordance with one or more aspects of the present disclosure.

FIG. 3 illustrates an example of a process flow that supports CSF reporting during beam refinement in accordance with one or more aspects of the present disclosure.

FIGS. 4 and 5 show block diagrams of devices that support CSF reporting during beam refinement in accordance with one or more aspects of the present disclosure.

FIG. 6 shows a block diagram of a communications manager that supports CSF reporting during beam refinement in accordance with one or more aspects of the present disclosure.

FIG. 7 shows a diagram of a system including a device that supports CSF reporting during beam refinement in accordance with one or more aspects of the present disclosure.

FIGS. 8 through 11 illustrate flowcharts showing methods that support channel state feedback reporting during beam refinement in accordance with one or more aspects of the present disclosure.

### DETAILED DESCRIPTION

In some wireless communications systems, a user equipment (UE) may transmit a channel state feedback (CSF) message to another wireless device, such as a network entity. The CSF message may include reference signal received power (RSRP) measurements for one or more synchronization signal blocks (SSBs). The SSBs may include SSBs of a serving cell, including serving SSBs and neighboring SSBs that each correspond to respective transmit beams (e.g., directional beams) used by a network entity for transmission of the SSBs. Further, the UE may use a set of receive beams (e.g., directional beams) to perform the measurements of the received SSBs, where the UE's receive beams may correspond to one or more of the transmit beams of the network entity. The UE may thus perform the RSRP measurements of the multiple SSBs using a quantity of corresponding beams, and the UE's beams may be refined via various beam refinement procedures, for example, to achieve a relatively narrow beam. As such, the beams used for initial measurements (e.g., prior to additional beam refinement) may be relatively wide beams, whereas other beams may be relatively narrow beams based on the status or progression of respective beam refinement procedures. In any case, the relative width of a particular beam (e.g., narrow, wide) may correspond to (e.g., result in) different measurement results when measuring SSBs.

The UE may transmit the CSF message to a network entity including RSRP values, and the network entity may trigger a beam switch based on the RSRP values included in the CSF message. However, the RSRP measurements for different SSBs (and for different beams) may, in some cases, be relatively inaccurate, as the UE may measure SSBs using different levels of beams (e.g., narrow beams versus wide beams). For instance, in cases where a serving SSB is measured with a relatively wide beam and neighbor SSBs are measured with a relatively narrow beam, a beam switch may be unnecessarily triggered due to measurement results obtained as a result of properties of the relatively narrow beams (e.g., serving SSBs otherwise measured with a narrow beam (instead of the wide beam) may provide a higher RSRP value relative to the neighbor SSBs). In other cases, a serving SSB measured using relatively narrow beams and neighbor SSBs measured with relatively wide beams may result in a delayed beam switch while beam refinement is performed to obtain a narrower beam level for measuring the neighbor SSBs (e.g., potentially delaying a beam switch that may have occurred sooner). As a result, measurements performed for CSF and beam management procedures while beam refinement is in progress may cause unnecessary (e.g., early) or delayed beam switches and increased latency, among other issues.

Techniques, systems, and devices describe herein enable a UE to use a beam refinement status to determine whether to report the RSRP measurements of neighboring SSBs. For example, RSRP measurements of the neighboring SSBs may be reported as part of the CSF message to the network entity if a beam refinement status of the corresponding beams for the neighboring SSBs, and a beam refinement status of the corresponding beams for the serving SSBs, have reached a concluded refinement status. The conclude refinement status may indicate that the beam refinement for the corresponding beams has been successful (e.g., the UE has reached a relatively narrowest beam level), that the refinement has failed (e.g., the UE has not reached the relatively narrowest beam level), or that the refinement has timed out (e.g., the UE has exceeded a threshold duration). Alternatively, the RSRP of the neighboring SSBs may be reported if the corresponding beams of the serving SSBs have achieved the concluded refinement status and the RSRP measurement of the neighboring SSBs satisfies a threshold RSRP measurement associated with the RSRP measurement of the serving SSBs. Here, the threshold RSRP measurement may be equivalent to a sum of an RSRP measurement of the serving SSBs and a hysteresis value, where the hysteresis value may be adjusted based on whether RSRP measurements for the neighboring SSBs have been previously reported (e.g., in a prior CSF report). As such, the described techniques enable additional controls and rules for reporting neighboring SSBs during ongoing beam refinement, which may result in decreased latency from beam switch procedures and increased efficiency in communications.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to channel state feedback (CSF) reporting during beam refinement.

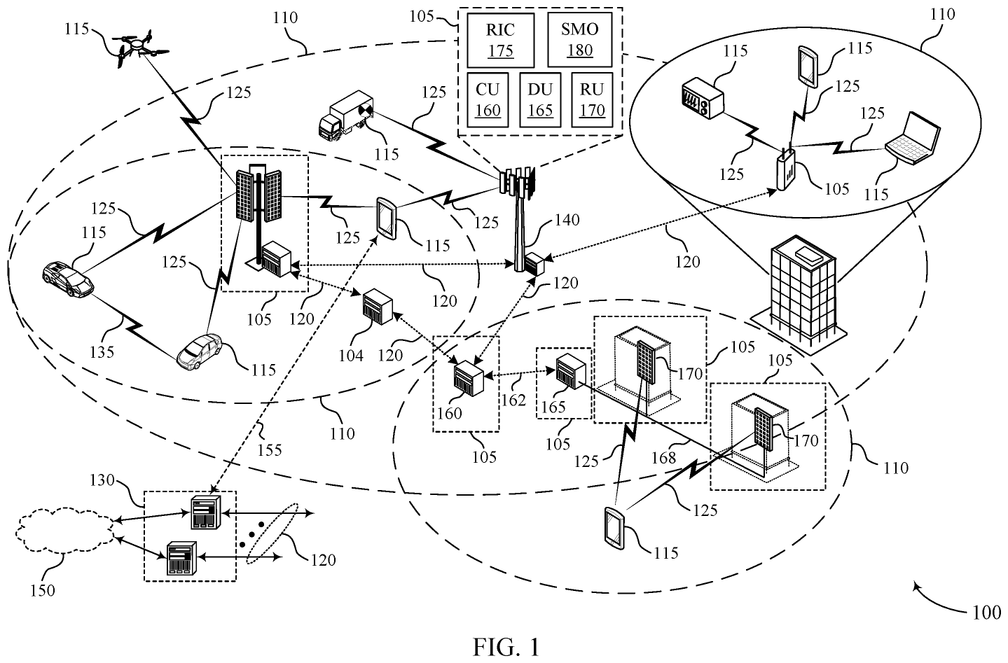

FIG. 1 illustrates an example of a wireless communications system 100 that supports CSF reporting during beam refinement in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CSF reporting during beam refinement as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation). In some aspects, a beam may be referred to as a directional beam, and may be configured with different levels or beam widths. A beam width may be associated with a signal strength based on a direction and radiation distance of an antenna. In some aspects, a beam width may correspond to an area or an angular separation between points of a beamforming lobe (e.g., a main lobe) used to transmit or receive a signal.

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Wireless communications system 100 may implement a beam refinement procedure for a first device, such as a UE 115, to communicate with a second device, such as a network entity 105. In some examples, the UE 115 may perform beam sweeping, for example, to acquire beam synchronization for communication with the network entity 105. The UE 115 may perform beam sweeping by selecting multiple beams at the UE 115 for communications. The multiple beams may be dynamic beams, static beams, or both. Dynamic beams may include beams that the UE 115 may position with beam steering, and static beams may be preconfigured in position at the UE 115. In some examples, the multiple beams may be relatively wider beams or relatively narrower beams. Beam management for such beams may be performed using a set of layer one (L1) and/or layer two (L2) procedures associated with acquisition and maintenance of UE beams, network entity beams, or a combination thereof, used for transmission and reception of uplink and/or downlink signals. Such L1/L2 procedures may include beam determination (e.g., selection of beams), beam measurement (e.g., measurement of characteristics of received beamformed signals), beam reporting (the UE 115 reporting information of one or more beamformed signals based on beam measurements), beam sweeping (e.g., covering a spatial area with respective beams transmitted during a time interval in a predetermined way), or the like.

The UE 115 may measure (e.g., may be scheduled by a network entity 105 to measure) beamformed signals transmitted on each of the transmit beams of the network entity 105 by measuring a beam metric of the corresponding synchronization signal blocks (SSBs) (e.g., corresponding SSB indices). The beam metric of the SSBs may be a RSRP or one or more other metrics. The RSRP may be a measurement of the received power level of a beamformed signal in the wireless network, such as an SSB. In some examples, the UE 115 may perform beam refinement and select an optimal beam based on comparing the beam metric (e.g., an RSRP measurement) for each SSB at each refinement stage. Additionally, or alternatively, the UE 115 may perform beam refinement by measuring each SSB with increasingly narrower beams, which may result in better directional alignment with beams at the network entity 105.

In some examples, the UE 115 may transmit a message, such as a CSF report to the network entity 105, and the message may include RSRP information for the multiple SSBs corresponding to beams at the UE 115. In this example, the network entity 105 may trigger a beam switch procedure for the beams at the network entity 105 based on the CSF report. The beam switch procedure may include the network entity 105 selecting a different beam for receiving signaling, transmitting signaling, or both. However, in some examples, such as in mmW communications systems, different SSB indices may be measured with different levels of beams (e.g., wide beams or narrow beams) based on the refinement stage of a beam. For instance, some measurements may be performed before a beam has been refined to a narrowest possible beam. In such cases, measurements of SSBs performed using different beam widths may not be easily compared when multiple beams are at differing refinement stages, and the measurement results may be different for different SSBs depending on a beam refinement status of a corresponding beam. Varying measurement results may trigger unnecessary or delayed beam switch procedures, which may result in increased latency and increased power consumption, among other issues.

As an illustrative example, a UE 115 may measure a first set of SSBs with narrower UE beams and a second set of SSBs with wider UE beams. The UE 115 may transmit the measurements (e.g., the RSRP measurements) to the network entity 105, and the network entity 105 may trigger an unnecessary beam switch procedure or an inaccurate beam switch procedure (e.g., an early beam switch procedure or a delayed beam switch procedure). For example, the UE 115 may transmit the RSRP measurements of multiple sets of SSBs. The network entity 105 may compare the measurements of serving SSBs (e.g., SSBs corresponding to the selected optimal beam in a serving cell) performed with wide UE beams and the measurements of neighboring SSBs (e.g., SSBs adjacent to the serving SSBs in the serving cell) performed with narrower beams, which may result in an inaccurate comparison and an unnecessary beam switch procedure (e.g., the RSRP measurement associated with the serving SSBs may be relatively greater than the RSRP measurement associated with neighboring SSBs). In another example, the UE 115 may compare the measurements of serving SSBs performed with narrower UE beams and the measurements of neighboring SSBs performed with wider beams. In this example, the UE 115 may refrain from transmitting the CSF report to the network entity 105 until the UE 115 measures the neighboring SSBs with narrower beams, which may result in increased latency. As such, early beam switch procedures or delayed beam switch procedures may negatively impact communications throughput between the UE 115 and the network entity 105 because the network entity 105 may switch to a relatively weaker beam based on the SSB measurements.

In order to enable the UE 115 to report accurate SSB measurements for the network entity 105 to enhance determinations of whether to trigger a beam switch procedure, the UE 115 may use a beam refinement status for reporting CSF. The UE 115 may perform RSRP measurements for primary component carrier (PCC) serving SSBs and neighboring SSBs. The UE 115 may determine whether to report an RSRP measurement of neighboring SSBs based on the beam refinement status, an RSRP measurement, or both. As such, additional controls and rules may be implemented to enhance reporting of measurements of SSBs (e.g., neighboring SSBs) during beam refinement, which may minimize, prevent, or avoid early beam switching and delayed beam switching, thereby preserving or enhancing communications efficiency for the UE 115.

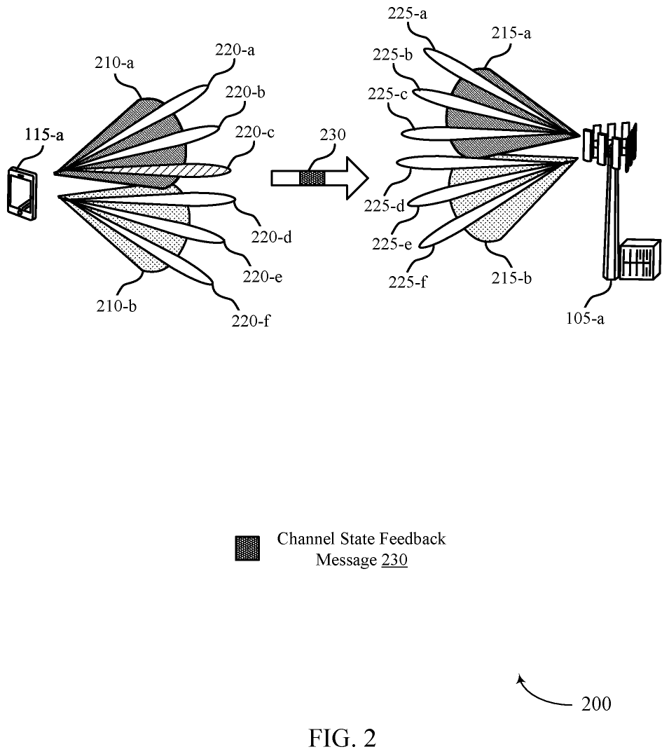

FIG. 2 illustrates an example of a wireless communications system 200 that supports CSF reporting during beam refinement in accordance with one or more aspects of the present disclosure. In some examples, wireless communications system 200 may implement aspects of wireless communications system 100. For example, wireless communications system 200 includes a network entity 105-a and a UE 115-a in a coverage area, which may be examples of the corresponding devices described with reference to FIG. 1.

Wireless communications system 200 may implement beam refinement procedures. For example, the UE 115-a and the network entity 105-a may perform beam sweeping to select directional beams for communication between the UE 115-a and the network entity 105-a. In such cases, the UE 115-a may perform measurements of different network entity beams to support the selection of transmit beams at the network entity 105-a and selection of receive beams at the UE 115-a. In some examples, the selected beams at the UE 115-a may include wide beams 210, such as wide beam 210-a and wide beam 210-b, and the selected beams at the network entity 105-a may include wide beams 215, such as wide beam 215-a and wide beam 215-b. In some examples, the UE 115-a may measure SSBs (e.g., respective SSBs having an SSB index that is mapped to a respective transmit beam) using wide beams 210 and a beam pair may be selected for communications between the UE 115-a and the network entity 105-a.

Wireless communications system 200 may support procedures to refine beams at both the UE 115-a and the network entity 105-a. For example, the network entity 105-a may refine transmit beams by sweeping narrow beams 225 (e.g., narrow beam 225-a through 225-f, beams that are relatively narrower than the wide beams 215-a, 215-b). The UE 115-a may identify a narrow beam 225 (e.g., narrow beam 225-c) having a relatively highest signal strength (e.g., based on a received signal strength determined by the UE 115-a) and report the identified beam (e.g., narrow beam 225-c) to the network entity 105-a. In addition, the UE 115-a may refine a wide beam 210 following the selection of a narrower beam by the network entity 105-a. In such cases, the network entity 105-a may transmit multiple signals (e.g., CSI-RSs, SSBs) using the narrow beam 225 identified by the UE 115-a (e.g., narrow beam 225-c) and the UE 115-a may sweep its own narrow beams 220 (e.g., narrow beams 220-a through 220-f) to identify a narrow beam 220 (e.g., narrow beam 220-c) that provides a relatively highest signal strength (e.g., highest RSRP) for beamformed signals sent by the network entity 105-a.

In some aspects, the UE 115-a may measure SSBs transmitted by the network entity 105-a using narrow beams 220 or wide beams 210, were the level of beam used for the measurements may be based on a stage of beam refinement at the UE 115-a. The UE 115-a may transmit a CSF report (e.g., a channel state feedback message 230) to the network entity 105-a using an uplink communication link. The channel state feedback message 230 may include RSRP information for the multiple SSBs corresponding to beams at the UE 115-a. The SSBs may include serving SSBs of a serving cell and neighboring SSBs of the serving cell. In this example, the network entity 105-a may trigger a beam switch procedure based on the information provided in the channel state feedback message 230. In some examples, however, when the UE 115-a measures different SSB indices with different levels of beams (e.g., wide beams 210 or narrow beams 220) based on the refinement stage, the measurement results may not be accurately compared between different SSB indices because the multiple beams may be at differing refinement stages. As such, the UE 115-a may measure a set of serving SSBs associated with a serving cell and a set of neighboring SSBs associated with the serving cell using different levels of beams. The variance of RSRPs for different SSBs (e.g., serving SSBs versus neighboring SSBs) for measurements performed using different beam levels may result in the network entity 105-a triggering an unnecessary beam switch procedure, which may result in increased latency and increased power consumption. That is, there may not be an equal comparison of RSRP measurements obtained using a wide beam with RSRP measurements obtained using a narrow beam, and it may be beneficial to take in account a beam refinement status when reporting RSRP measurements.

Thus, to enable the UE 115-a to accurately report SSB measurements to the network entity 105-a, the UE 115-a may use a beam refinement status. For example, the UE 115-a may determine whether to include an RSRP measurement of a set of neighboring SSBs in the channel state feedback message 230 based on the beam refinement status, the RSRP measurement, or both. In some aspects, the UE 115-a may include an RSRP measurement for a set of serving SSBs in the channel state feedback message 230 (e.g., regardless of the refinement status). The UE 115-a may determine (e.g., track) a beam refinement status for each SSB, where the beam refinement status may be one or more of a refinement in progress status, a refinement failure status, a refinement timeout status, a refinement success status, or a refinement concluded status. The refinement in progress status may indicate that the beam refinement procedure at the UE 115-a is ongoing, and the UE 115-a may be in the process of measuring beamformed signals using the narrow beams 220. The refinement failure status may indicate that the UE 115-a has failed to complete the beam refinement procedure (e.g., the refinement is stuck at a local maxima of the SSB measurements) and the UE 115-a has been unable to select one of the narrow beams 220 based on the measurements. The refinement timeout status may indicate that a time threshold associated with the beam refinement procedure has elapsed (e.g., the refinement procedure has exceeded a threshold duration) for measuring SSBs. The refinement success status may indicate that the UE 115-a has performed the beam refinement procedure and a directional beam has been refined to a narrowest beam (e.g., one of the narrow beams 220), where the UE 115-a has selected an optimal beam corresponding to a measured SSB. The refinement concluded status may indicate a refinement failure status, a refinement timeout status, or a refinement success status.

The UE 115-a may determine whether to report the RSRP measurement (e.g., L1 reporting) of the set of neighboring SSBs based on a readiness metric (e.g., an SSB readiness metric), which may correspond to a beam refinement status and further indicate a value of an SSB readiness flag (e.g., true or false) at the UE 115-a. Here, the SSB readiness metric may indicate whether the UE 115-a has reached the refinement concluded status for the beam refinement procedure of a beam corresponding to measured SSBs. The SSB readiness flag (e.g., a readiness indicator) may be true if the set of SSBs is associated with the refinement concluded status. Alternatively, the SSB readiness flag may be false if the set of SSBs is not associated with refinement concluded status (e.g., if the set of SSBs is associated with the refinement in progress status).

The UE 115-a may determine to include the RSRP measurements of the set of serving SSBs and/or the RSRP measurements of the set of neighboring SSBs based on the readiness flag. For example, if the SSB readiness flag for the set of serving SSBs is true, the UE 115-a may further determine whether the SSB readiness flag for the set of neighboring SSBs is true. If the SSB readiness flag for the set of neighboring SSBs is also true, the UE 115-a may include the RSRP measurement of the set of serving SSBs and the RSRP measurement of the set of neighboring SSBs in the channel state feedback message 230. In other examples, if the SSB readiness flag for the set of serving SSBs is true, but the SSB readiness flag for the set of neighboring SSBs is false, the UE 115-a may determine whether the RSRP measurement of the set of neighboring SSBs (e.g., neighbor SSB RSRP) is greater than a sum of the RSRP measurement of the set of serving SSBs (e.g., serving SSB RSRP) and a hysteresis threshold (e.g., Hyst1). In other words, the UE 115-a may compute whether: neighbor SSB RSRP >serving SSB RSRP+Hyst1 when the readiness flag of the serving SSB is true and the readiness flag of the neighbor SSB is false. If the RSRP measurement of the set of neighboring SSBs is greater than the sum of the RSRP measurement of the set of serving SSBs and the hysteresis threshold, the UE 115-a may include the RSRP measurement of the set of serving SSBs and the RSRP measurement of the set of neighboring SSBs in the channel state feedback message 230. Alternatively, if the SSB readiness metric for the set of neighboring SSBs is false and the RSRP measurement of the set of neighboring SSBs is less than the sum of the RSRP measurement of the set of serving SSBs and the hysteresis threshold, the UE 115-a may include the RSRP measurement of the set of serving SSBs in the channel state feedback message 230, and the UE 115-a may refrain from including the RSRP measurement of the set of neighboring SSBs in the channel state feedback message 230. In some examples, if the SSB readiness flag for the set of serving SSBs is false, the UE 115-a may include the RSRP measurement of the set of serving SSBs in the channel state feedback message 230, and the UE 115-a may refrain from including the RSRP measurement of the set of neighboring SSBs in the channel state feedback message 230 (e.g., the UE 115-a may report L1 RSRP for the serving SSB measurements regardless of the refinement status of corresponding beams).

In some examples, the UE 115-a may adjust the hysteresis threshold based on whether the neighbor SSB RSRP has been previously reported. For example, when a beam associated with a neighboring SSB is still under refinement, and if the UE 115-a has not previously reported the RSRP measurement of the neighboring SSBs (e.g., has previously excluded the RSRP measurement of the neighboring SSBs) to the network entity 105-a as part of the channel state feedback message 230, the UE 115-a may increase the hysteresis threshold. Such an increase of the hysteresis threshold may decrease a likelihood that the neighbor SSB RSRP is reported (e.g., unless the neighboring SSB RSRP becomes greater (e.g., significantly greater) than the serving SSB RSRP, which may help ensure that beam switching is performed at an appropriate time).

In another example, when a beam associated with a neighbor SSB is still under refinement, and if the UE 115-a has previously reported the RSRP measurement of the neighboring SSBs to the network entity 105-a (e.g., via a previous channel state feedback message 230), the UE 115-a may decrease the hysteresis threshold. Here, the decreased hysteresis threshold may result in an increase likelihood that the RSRP measurement of the neighboring SSB will continue to be reported.

The UE 115-a adjusting the hysteresis threshold may result in relatively decreased fluctuations in the beam metrics. For example, the SSB readiness flag for the set of neighboring SSBs may false (e.g., if the set of SSBs is associated with the refinement in progress status) and the RSRP measurement of the set of neighboring SSBs may be greater than the sum of the RSRP measurement of the set of serving SSBs and the hysteresis threshold. In this example, the UE 115-a may report the RSRP measurement of the set of neighboring SSBs in the channel state feedback message 230 until a difference (e.g., a delta) between the RSRP measurement of the set of neighboring SSBs and the RSRP measurement of the set of serving SSBs fails to satisfy the adjusted hysteresis threshold (e.g., decreased hysteresis threshold).

In some examples, such as in connected discontinuous reception (CDRX) mode, the UE 115-a may trigger a greater quantity of measurement occasions to perform the beam refinement procedure. CDRX mode may enable to the UE to monitor a downlink channel during monitoring occasions of pre-configured awake cycles. For example, if the set of serving SSBs and the set of neighboring SSBs are both associated with a refinement in progress status, the UE 115-a may trigger more measurement occasions to decrease the time to perform the beam refinement procedure for the sets of SSBs, which may prevent or avoid early beam switching and late beam switching, thereby preserving communications efficiency for the UE 115-a and the network entity 105-a. The UE 115-a may transmit the channel state feedback message 230 to the network entity 105-a, and the channel state feedback message may include the RSRP measurement of the set of serving SSBs and the RSRP measurement of the set of neighboring SSBs based on the beam refinement status, the RSRP measurements, or both. The UE 115-a determining whether to include the RSRP measurement of the neighboring SSBs may result in the network entity 105-a triggering less unnecessary beam switch procedures, which may decrease latency and increase efficiency in communications.

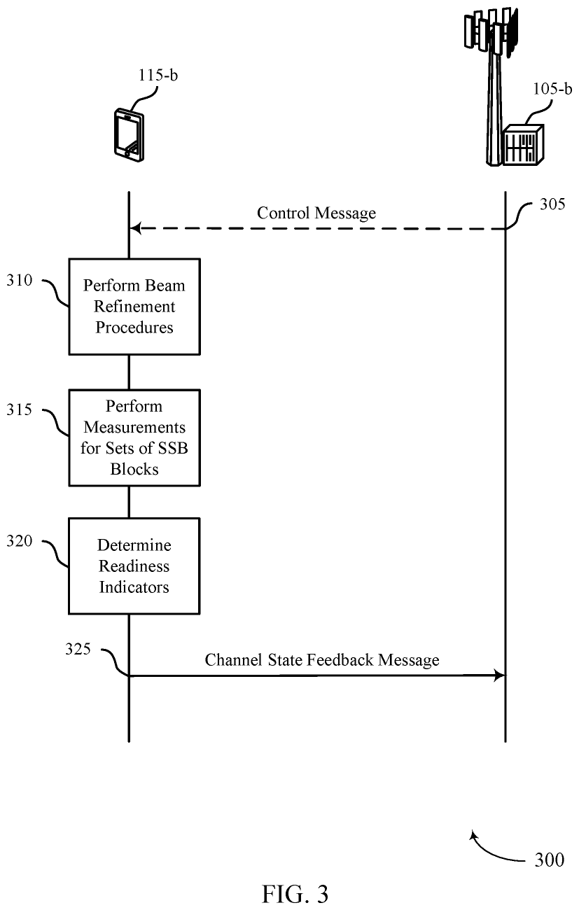

FIG. 3 illustrates an example of a process flow 300 that supports CSF reporting during beam refinement in accordance with one or more aspects of the present disclosure. In some examples, the process flow 300 may implement aspects of wireless communications system 100 and wireless communications system 200. The process flow 300 may include a UE 115-b and a network entity 105-b, which may be examples of a UE 115 and a network entity 105 as described herein with reference to FIGS. 1 and 2. The process flow 300 may illustrate an example of techniques which enable a UE 115 to determine whether to transmit neighboring SSB measurements (e.g., SSB RSRP values). For example, the UE 115 may be configured to report a neighboring SSB measurement based on the RSRP measurement, a beam refinement status, or both.

At 305, in some examples, a network entity 105-b may transmit a control message indicating a configuration for performing measurements of a first set of SSBs and a second set of SSBs. The configuration may indicate a first quantity of measurement occasions that satisfy a threshold quantity of measurement occasions. The first quantity of measurement occasions may be based on the UE 115-b operating in a discontinuous reception mode and a first refinement status or a second refinement status, or both.

At 310, the UE 115-b may perform respective beam refinement procedures for a first set of directional beams and a second set of directional beams. The first set of directional beams may correspond to the first set of SSBs of a serving cell and the second set of directional beams corresponding to the second set of SSBs of the serving cell. A first refinement status for the first set of SSBs and a second refinement status for the second set of SSBs are based on the respective beam refinement procedures. In some examples, the first refinement status or the second refinement status, or both, includes an in-progress refinement status based on one or more directional beams being at a beam level that is less than a threshold beam level. In some examples, the first set of SSBs includes a set of serving SSBs and the second set of SSBs includes a set of neighboring SSBs.

At 315, the UE 115-b may perform measurements of the first set of SSBs and the second set of SSBs. A first power metric for the first set of SSBs and a second power metric for the second set of SSBs are based on the measurements.

At 320, the UE 115-b may determine that a first readiness indicator (e.g., a readiness flag) for the first set of SSBs is true based on the first refinement status for the first set of SSBs. The UE 115-b may determine that a second readiness indicator (e.g., a readiness flag) for the second set of SSBs is true based on the second refinement status for the second set of SSBs. The CSF may include both the first power metric and the second power metric based on the first readiness indicator and the second readiness indicator being true. In some examples, the first readiness indicator may be true based on the first refinement status for the first set of SSBs including a refinement concluded status. The second readiness indicator may be true based on the second refinement status for the second set of SSBs including the refinement concluded status.

In some examples, the refinement concluded status is associated with a refinement failure status, or a refinement timeout status, or a refinement success status. The first refinement status or the second refinement status, or both, may include a refinement failure status based on a failure of multiple attempts to refine at least one directional beam to a threshold beam level. In some examples, the first refinement status or the second refinement status, or both, includes a refinement timeout status based on duration for refining at least one directional beam exceeding a threshold duration. In some examples, the first refinement status or the second refinement status, or both, includes a refinement success status based on refining one or more directional beams to a threshold beam level. In some examples, the first power metric includes a first RSRP and the second power metric includes a second RSRP.

In some examples, the UE 115-b may determine that a first readiness indicator for the first set of SSBs is true based on the first refinement status for the first set of SSBs. The UE 115-b may determine that the second power metric satisfies the threshold. The CSF includes both the first power metric and the second power metric based on the first readiness indicator being true and the second power metric satisfying the threshold. The threshold may include a sum of the first power metric and a hysteresis value. In some examples, the UE 115-b may generate the hysteresis value based on whether CSF for the second set of SSBs has been previously reported. In some examples, the UE 115-b may decrease the hysteresis value based on previously reporting the channel state feedback for the second set of SSBs. Additionally, or alternatively, the UE 115-b may increase the hysteresis value based on the CSF for the second set of SSBs being excluded from previous reporting.

In some examples, the UE 115-b may determine that a readiness indicator for the second set of SSBs is false based on the second refinement status. The UE 115-b may determine that the second power metric fails to satisfy the threshold. The CSF includes the first power metric based on the readiness indicator being false and the second power metric failing to satisfy the threshold

At 325, the UE 115-b may transmit a message to the network entity 105-b indicating CSF including the first power metric or both the first power metric and the second power metric. The CSF comprises both the first power metric and the second power metric based on the first refinement status and the second refinement status or based on the second power metric satisfying a threshold.

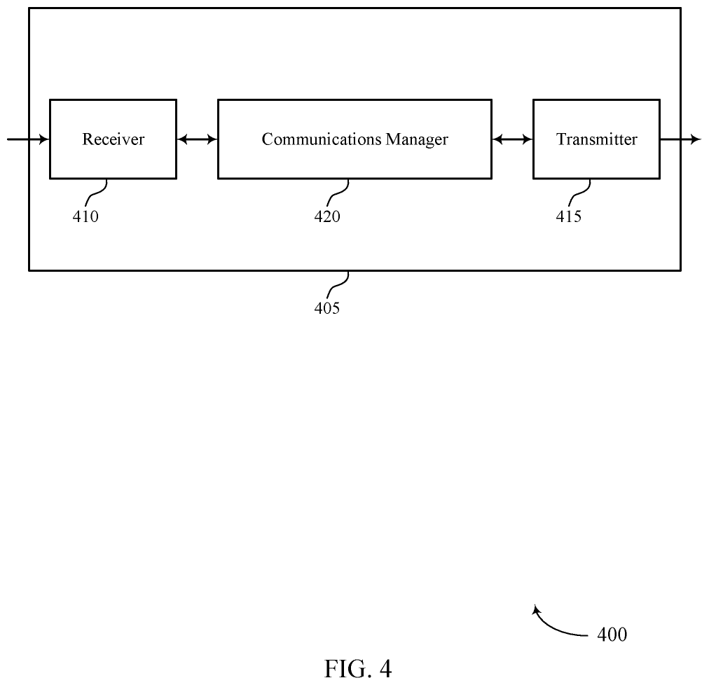

FIG. 4 shows a block diagram 400 of a device 405 that supports CSF reporting during beam refinement in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to CSF reporting during beam refinement). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to CSF reporting during beam refinement). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of CSF reporting during beam refinement as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The communications manager 420 may be configured as or otherwise support a means for performing measurements of the first set of synchronization signal blocks and the second set of synchronization signal blocks, where a first power metric for the first set of synchronization signal blocks and a second power metric for the second set of synchronization signal blocks are based on the measurements. The communications manager 420 may be configured as or otherwise support a means for transmitting a message indicating CSF including the first power metric or both the first power metric and the second power metric, where the CSF includes both the first power metric and the second power metric based on the first refinement status and the second refinement status or based on the second power metric satisfying a threshold.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing and reduced power consumption. For example, by transmitting a CSF message to determine whether to perform a beam switch procedure based on a threshold, the processor for the device 405 may more efficiently trigger the beam switch procedure and reduce power use.

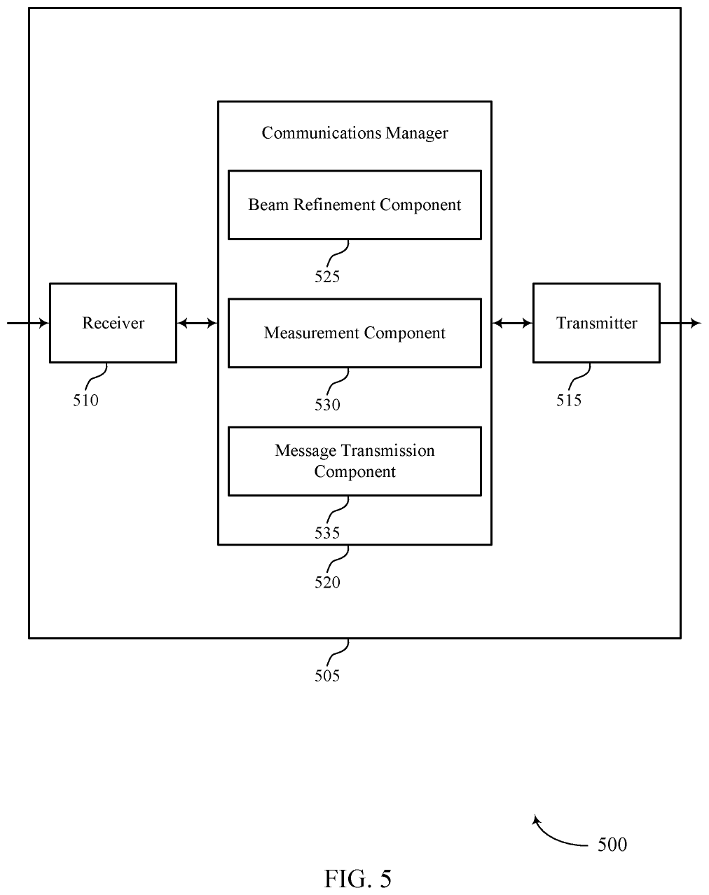

FIG. 5 shows a block diagram 500 of a device 505 that supports CSF reporting during beam refinement in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to CSF reporting during beam refinement). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CSF reporting during beam refinement). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of CSF reporting during beam refinement as described herein. For example, the communications manager 520 may include a beam refinement component 525, a measurement component 530, a message transmission component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The beam refinement component 525 may be configured as or otherwise support a means for performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The measurement component 530 may be configured as or otherwise support a means for performing measurements of the first set of synchronization signal blocks and the second set of synchronization signal blocks, where a first power metric for the first set of synchronization signal blocks and a second power metric for the second set of synchronization signal blocks are based on the measurements. The message transmission component 535 may be configured as or otherwise support a means for transmitting a message indicating CSF including the first power metric or both the first power metric and the second power metric, where the CSF includes both the first power metric and the second power metric based on the first refinement status and the second refinement status or based on the second power metric satisfying a threshold.

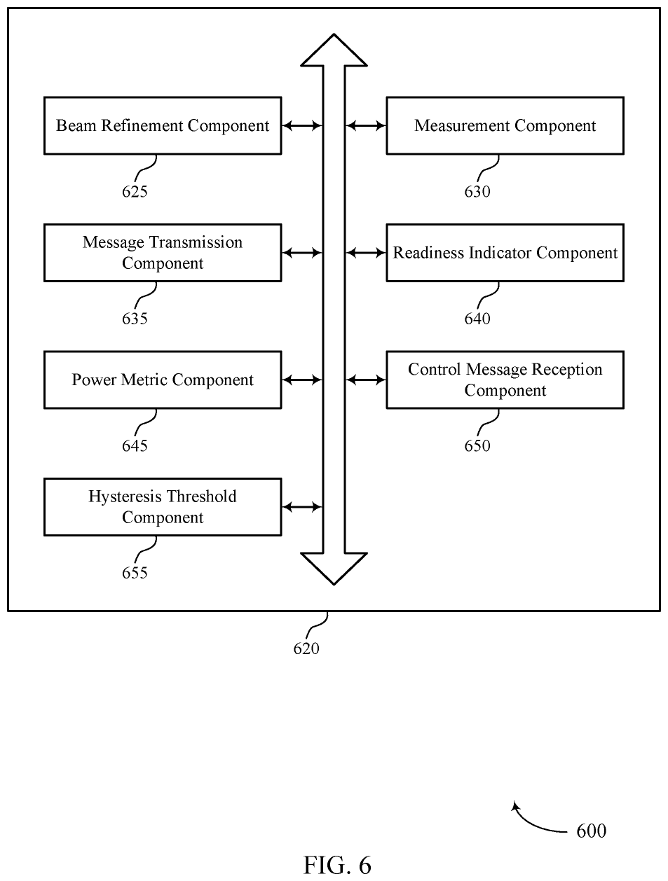

FIG. 6 shows a block diagram 600 of a communications manager 620 that supports CSF reporting during beam refinement in accordance with one or more aspects of the present disclosure. The communications manager 620 may be an example of aspects of a communications manager 420, a communications manager 520, or both, as described herein. The communications manager 620, or various components thereof, may be an example of means for performing various aspects of CSF reporting during beam refinement as described herein. For example, the communications manager 620 may include a beam refinement component 625, a measurement component 630, a message transmission component 635, a readiness indicator component 640, a power metric component 645, a control message reception component 650, a hysteresis threshold component 655, or any combination thereof. Each of these components may communicate, directly or indirectly, with one another (e.g., via one or more buses).

The communications manager 620 may support wireless communication at a UE in accordance with examples as disclosed herein. The beam refinement component 625 may be configured as or otherwise support a means for performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The measurement component 630 may be configured as or otherwise support a means for performing measurements of the first set of synchronization signal blocks and the second set of synchronization signal blocks, where a first power metric for the first set of synchronization signal blocks and a second power metric for the second set of synchronization signal blocks are based on the measurements. The message transmission component 635 may be configured as or otherwise support a means for transmitting a message indicating CSF including the first power metric or both the first power metric and the second power metric, where the CSF includes both the first power metric and the second power metric based on the first refinement status and the second refinement status or based on the second power metric satisfying a threshold.

In some examples, the readiness indicator component 640 may be configured as or otherwise support a means for determining that a first readiness indicator for the first set of synchronization signal blocks is true based on the first refinement status for the first set of synchronization signal blocks. In some examples, the readiness indicator component 640 may be configured as or otherwise support a means for determining that a second readiness indicator for the second set of synchronization signal blocks is true based on the second refinement status for the second set of synchronization signal blocks, where the CSF includes both the first power metric and the second power metric based on the first readiness indicator and the second readiness indicator being true.

In some examples, the first readiness indicator is true based on the first refinement status for the first set of synchronization signal blocks including a refinement concluded status. In some examples, the second readiness indicator is true based on the second refinement status for the second set of synchronization signal blocks including the refinement concluded status.

In some examples, the refinement concluded status is associated with a refinement failure status, or a refinement timeout status, or a refinement success status.

In some examples, the readiness indicator component 640 may be configured as or otherwise support a means for determining that a first readiness indicator for the first set of synchronization signal blocks is true based on the first refinement status for the first set of synchronization signal blocks. In some examples, the power metric component 645 may be configured as or otherwise support a means for determining that the second power metric satisfies the threshold, where the CSF includes both the first power metric and the second power metric based on the first readiness indicator being true and the second power metric satisfying the threshold.

In some examples, the threshold includes a sum of the first power metric and a hysteresis value.

In some examples, the hysteresis threshold component 655 may be configured as or otherwise support a means for generating the hysteresis value based on whether CSF for the second set of synchronization signal blocks has been previously reported.

In some examples, the hysteresis threshold component 655 may be configured as or otherwise support a means for decreasing the hysteresis value based on previously reporting the CSF for the second set of synchronization signal blocks.

In some examples, the hysteresis threshold component 655 may be configured as or otherwise support a means for increasing the hysteresis value based on the CSF for the second set of synchronization signal blocks being excluded from previous reporting.

In some examples, the control message reception component 650 may be configured as or otherwise support a means for receiving a control message indicating a configuration for performing the measurements of the first set of synchronization signal blocks and the second set of synchronization signal blocks, where the configuration indicates a first quantity of measurement occasions that satisfy a threshold quantity of measurement occasions, the first quantity of measurement occasions being based on the UE operating in a discontinuous reception mode and the first refinement status or the second refinement status, or both.

In some examples, the readiness indicator component 640 may be configured as or otherwise support a means for determining that a readiness indicator for the second set of synchronization signal blocks is false based on the second refinement status. In some examples, the power metric component 645 may be configured as or otherwise support a means for determining that the second power metric fails to satisfy the threshold, where the CSF includes the first power metric based on the readiness indicator being false and the second power metric failing to satisfy the threshold.

In some examples, the first refinement status or the second refinement status, or both, includes an in-progress refinement status based on one or more directional beams being at a beam level that is less than a threshold beam level.

In some examples, the first refinement status or the second refinement status, or both, includes a refinement failure status based on a failure of a set of multiple attempts to refine at least one directional beam to a threshold beam level.

In some examples, the first refinement status or the second refinement status, or both, includes a refinement timeout status based on duration for refining at least one directional beam exceeding a threshold duration.

In some examples, the first refinement status or the second refinement status, or both, includes a refinement success status based on refining one or more directional beams to a threshold beam level.

In some examples, the first power metric includes a first reference signal received power and the second power metric includes a second reference signal received power.

In some examples, the first set of synchronization signal blocks includes a set of serving synchronization signal blocks and the second set of synchronization signal blocks includes a set of neighboring synchronization signal blocks.

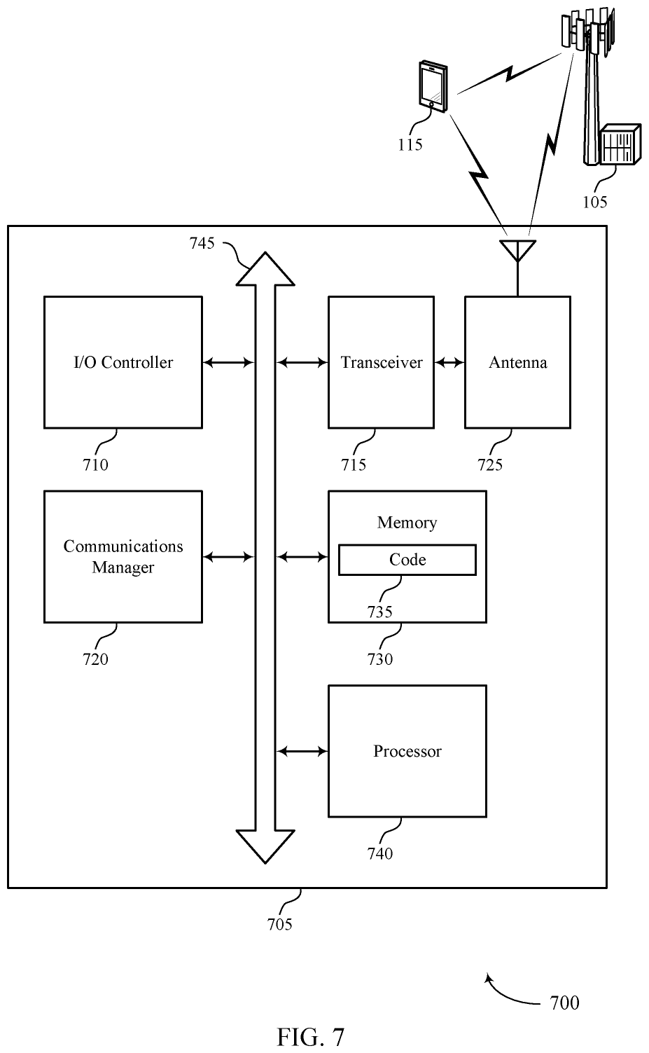

FIG. 7 shows a diagram of a system 700 including a device 705 that supports CSF reporting during beam refinement in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting CSF reporting during beam refinement). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for performing respective beam refinement procedures for a first set of directional beams and a second, different set of directional beams, the first set of directional beams corresponding to a first set of synchronization signal blocks of a serving cell and the second set of directional beams corresponding to a second set of synchronization signal blocks of the serving cell (e.g., the first set of synchronization signal blocks may be different from the second set of synchronization signal blocks). In some examples, a first refinement status for the first set of synchronization signal blocks and a second refinement status for the second set of synchronization signal blocks are based on the respective beam refinement procedures. The communications manager 720 may be configured as or otherwise support a means for performing measurements of the first set of synchronization signal blocks and the second set of synchronization signal blocks, where a first power metric for the first set of synchronization signal blocks and a second power metric for the second set of synchronization signal blocks are based on the measurements. The communications manager 720 may be configured as or otherwise support a means for transmitting a message indicating CSF including the first power metric or both the first power metric and the second power metric, where the CSF includes both the first power metric and the second power metric based on the first refinement status and the second refinement status or based on the second power metric satisfying a threshold.

By including or configuring the communications manager 720 in accordance with examples as described herein, the device 705 may support techniques for reduced latency, reduced power consumption, and improved coordination between devices. For example, by transmitting a CSF message to a network entity, the network entity may determine whether to perform a beam switch procedure based on a threshold. Performing the beam switched based on the threshold may result in the processor for the device 705 may more efficiently triggering the beam switch procedure and reducing latency.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of CSF reporting during beam refinement as described herein, or the processor 740 and the memory 730 may be otherwise configured to perform or support such operations.

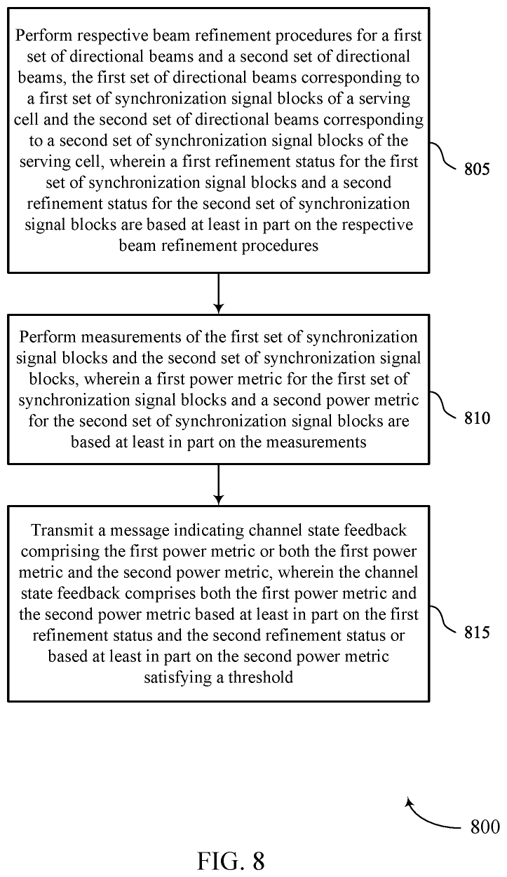

FIG. 8 shows a flowchart illustrating a method 800 that supports CSF reporting during beam refinement in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The operations of 805 may be performed in accordance with examples as disclosed herein. In some examples, aspects of the operations of 805 may be performed by a beam refinement component 625 as described with reference to FIG. 6.

At 810, the method may include performing measurements of the first set of synchronization signal blocks and the second set of synchronization signal blocks, where a first power metric for the first set of synchronization signal blocks and a second power metric for the second set of synchronization signal blocks are based on the measurements. The operations of 810 may be performed in accordance with examples as disclosed herein. In some examples, aspects of the operations of 810 may be performed by a measurement component 630 as described with reference to FIG. 6.

At 815, the method may include transmitting a message indicating CSF including the first power metric or both the first power metric and the second power metric, where the CSF includes both the first power metric and the second power metric based on the first refinement status and the second refinement status or based on the second power metric satisfying a threshold. The operations of 815 may be performed in accordance with examples as disclosed herein. In some examples, aspects of the operations of 815 may be performed by a message transmission component 635 as described with reference to FIG. 6.

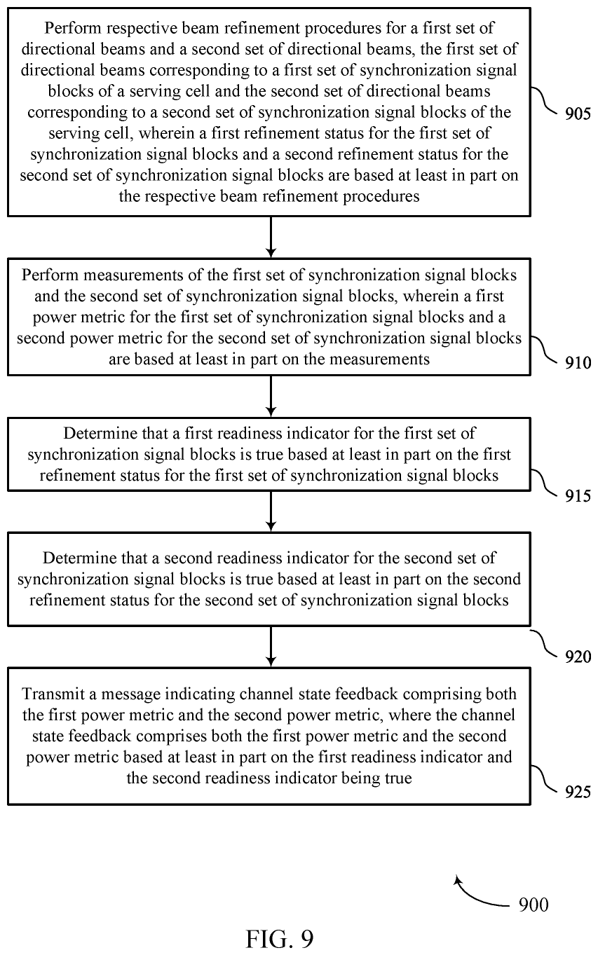

FIG. 9 shows a flowchart illustrating a method 900 that supports CSF reporting during beam refinement in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The operations of 905 may be performed in accordance with examples as disclosed herein. In some examples, aspects of the operations of 905 may be performed by a beam refinement component 625 as described with reference to FIG. 6.

At 910, the method may include performing measurements of the first set of synchronization signal blocks and the second set of synchronization signal blocks, where a first power metric for the first set of synchronization signal blocks and a second power metric for the second set of synchronization signal blocks are based on the measurements. The operations of 910 may be performed in accordance with examples as disclosed herein. In some examples, aspects of the operations of 910 may be performed by a measurement component 630 as described with reference to FIG. 6.

At 915, the method may include determining that a first readiness indicator for the first set of synchronization signal blocks is true based on the first refinement status for the first set of synchronization signal blocks. The operations of 915 may be performed in accordance with examples as disclosed herein. In some examples, aspects of the operations of 915 may be performed by a readiness indicator component 640 as described with reference to FIG. 6.

At 920, the method may include determining that a second readiness indicator for the second set of synchronization signal blocks is true based on the second refinement status for the second set of synchronization signal blocks. The operations of 920 may be performed in accordance with examples as disclosed herein. In some examples, aspects of the operations of 920 may be performed by a readiness indicator component 640 as described with reference to FIG. 6.

At 925, the method may include transmitting a message indicating CSF including both the first power metric and the second power metric, where the CSF includes both the first power metric and the second power metric based on the first readiness indicator and the second readiness indicator being true. The operations of 925 may be performed in accordance with examples as disclosed herein. In some examples, aspects of the operations of 925 may be performed by a message transmission component 635 as described with reference to FIG. 6.

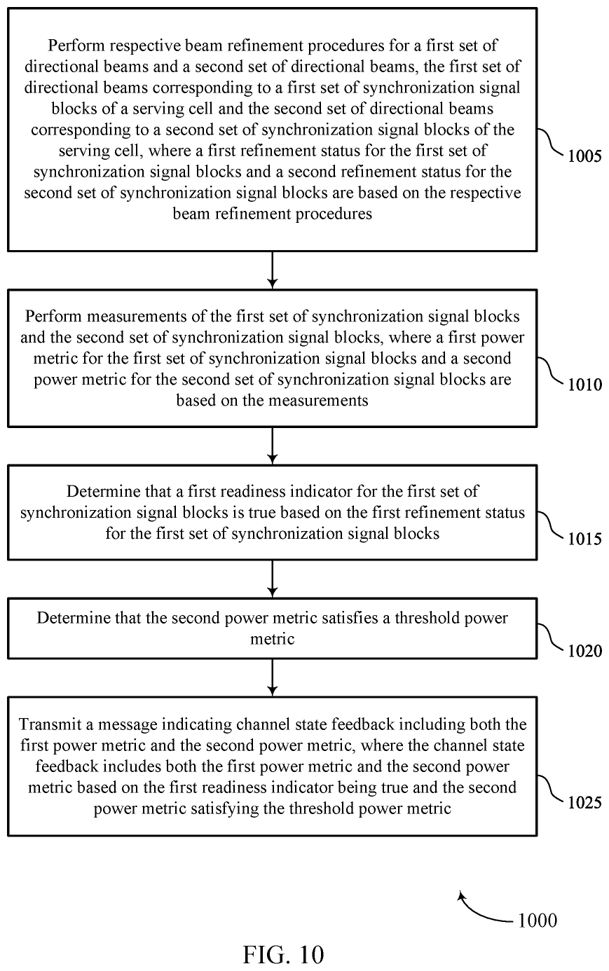

FIG. 10 illustrates a flowchart illustrating a method 1000 that supports CSF reporting during beam refinement in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The operations of 1005 may be performed in accordance with examples as disclosed herein. In some examples, aspects of the operations of 1005 may be performed by a beam refinement component 625 as described with reference to FIG. 6.

At 1010, the method may include performing measurements of the first set of synchronization signal blocks and the second set of synchronization signal blocks, where a first power metric for the first set of synchronization signal blocks and a second power metric for the second set of synchronization signal blocks are based on the measurements. The operations of 1010 may be performed in accordance with examples as disclosed herein. In some examples, aspects of the operations of 1010 may be performed by a measurement component 630 as described with reference to FIG. 6.

At 1015, the method may include determining that a first readiness indicator for the first set of synchronization signal blocks is true based on the first refinement status for the first set of synchronization signal blocks. The operations of 1015 may be performed in accordance with examples as disclosed herein. In some examples, aspects of the operations of 1015 may be performed by a readiness indicator component 640 as described with reference to FIG. 6.

At 1020, the method may include determining that the second power metric satisfies a threshold power metric (e.g., a threshold RSRP). The operations of 1020 may be performed in accordance with examples as disclosed herein. In some examples, aspects of the operations of 1020 may be performed by a power metric component 645 as described with reference to FIG. 6.

At 1025, the method may include transmitting a message indicating CSF including both the first power metric and the second power metric, where the CSF includes both the first power metric and the second power metric based on the first readiness indicator being true and the second power metric satisfying the threshold power metric. The operations of 1025 may be performed in accordance with examples as disclosed herein. In some examples, aspects of the operations of 1025 may be performed by a message transmission component 635 as described with reference to FIG. 6.

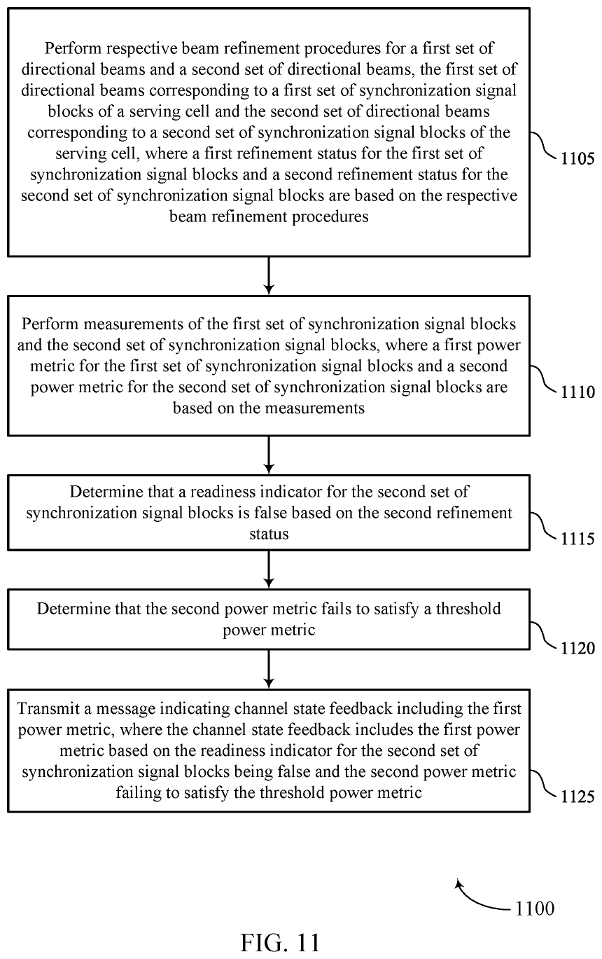

FIG. 11 illustrates a flowchart illustrating a method 1100 that supports CSF reporting during beam refinement in accordance with one or more aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, where a first refinement status for the first set of synchronization signal blocks and a second refinement status for the second set of synchronization signal blocks are based on the respective beam refinement procedures. The operations of 1105 may be performed in accordance with examples as disclosed herein. In some examples, aspects of the operations of 1105 may be performed by a beam refinement component 625 as described with reference to FIG. 6.

At 1110, the method may include performing measurements of the first set of synchronization signal blocks and the second set of synchronization signal blocks, where a first power metric for the first set of synchronization signal blocks and a second power metric for the second set of synchronization signal blocks are based on the measurements. The operations of 1110 may be performed in accordance with examples as disclosed herein. In some examples, aspects of the operations of 1110 may be performed by a measurement component 630 as described with reference to FIG. 6.

At 1115, the method may include determining that a readiness indicator for the second set of synchronization signal blocks is false based on the second refinement status. The operations of 1115 may be performed in accordance with examples as disclosed herein. In some examples, aspects of the operations of 1115 may be performed by a readiness indicator component 640 as described with reference to FIG. 6.

At 1120, the method may include determining that the second power metric fails to satisfy a threshold power metric (e.g., a threshold RSRP). The operations of 1120 may be performed in accordance with examples as disclosed herein. In some examples, aspects of the operations of 1120 may be performed by a power metric component 645 as described with reference to FIG. 6.

At 1125, the method may include transmitting a message indicating CSF including the first power metric, where the CSF includes the first power metric based on the readiness indicator for the second set of synchronization signal blocks being false and the second power metric failing to satisfy the threshold power metric. The operations of 1125 may be performed in accordance with examples as disclosed herein. In some examples, aspects of the operations of 1125 may be performed by a message transmission component 635 as described with reference to FIG. 6.

The following provides an overview of aspects of the present disclosure:

Aspect 1: A method for wireless communication at a UE, comprising: performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, wherein a first refinement status for the first set of synchronization signal blocks and a second refinement status for the second set of synchronization signal blocks are based at least in part on the respective beam refinement procedures; performing measurements of the first set of synchronization signal blocks and the second set of synchronization signal blocks, wherein a first power metric for the first set of synchronization signal blocks and a second power metric for the second set of synchronization signal blocks are based at least in part on the measurements; and transmitting a message indicating channel state feedback comprising the first power metric or both the first power metric and the second power metric, wherein the channel state feedback comprises both the first power metric and the second power metric based at least in part on the first refinement status and the second refinement status or based at least in part on the second power metric satisfying a threshold.

Aspect 2: The method of aspect 1, further comprising: determining that a first readiness indicator for the first set of synchronization signal blocks is true based at least in part on the first refinement status for the first set of synchronization signal blocks; and determining that a second readiness indicator for the second set of synchronization signal blocks is true based at least in part on the second refinement status for the second set of synchronization signal blocks, wherein the channel state feedback comprises both the first power metric and the second power metric based at least in part on the first readiness indicator and the second readiness indicator being true.

Aspect 3: The method of aspect 2, wherein the first readiness indicator is true based at least in part on the first refinement status for the first set of synchronization signal blocks comprising a refinement concluded status; and the second readiness indicator is true based at least in part on the second refinement status for the second set of synchronization signal blocks comprising the refinement concluded status.

Aspect 4: The method of aspect 3, wherein the refinement concluded status is associated with a refinement failure status, or a refinement timeout status, or a refinement success status.

Aspect 5: The method of any of aspects 1 through 4, further comprising: determining that a first readiness indicator for the first set of synchronization signal blocks is true based at least in part on the first refinement status for the first set of synchronization signal blocks; and determining that the second power metric satisfies the threshold, wherein the channel state feedback comprises both the first power metric and the second power metric based at least in part on the first readiness indicator for the first set of synchronization signal blocks being true and the second power metric satisfying the threshold.

Aspect 6: The method of aspect 5, wherein the threshold comprises a sum of the first power metric and a hysteresis value.

Aspect 7: The method of aspect 6, further comprising: generating the hysteresis value based at least in part on whether channel state feedback for the second set of synchronization signal blocks has been previously reported.

Aspect 8: The method of aspect 7, further comprising: decreasing the hysteresis value based at least in part on previously reporting the channel state feedback for the second set of synchronization signal blocks.

Aspect 9: The method of aspect 7, further comprising: increasing the hysteresis value based at least in part on the channel state feedback for the second set of synchronization signal blocks being excluded from previous reporting.

Aspect 10: The method of any of aspects 1 through 9, further comprising: receiving a control message indicating a configuration for performing the measurements of the first set of synchronization signal blocks and the second set of synchronization signal blocks, wherein the configuration indicates a first quantity of measurement occasions that satisfy a threshold quantity of measurement occasions, the first quantity of measurement occasions being based at least in part on the UE operating in a discontinuous reception mode and the first refinement status or the second refinement status, or both.

Aspect 11: The method of any of aspects 1 through 10, further comprising: determining that a readiness indicator for the second set of synchronization signal blocks is false based at least in part on the second refinement status; and determining that the second power metric fails to satisfy the threshold, wherein the channel state feedback comprises the first power metric based at least in part on the readiness indicator for the second set of synchronization signal blocks being false and the second power metric failing to satisfy the threshold.

Aspect 12: The method of any of aspects 1 through 11, wherein the first refinement status or the second refinement status, or both, comprises an in-progress refinement status based at least in part on one or more directional beams being at a beam level that is less than a threshold beam level.

Aspect 13: The method of any of aspects 1 through 11, wherein the first refinement status or the second refinement status, or both, comprises a refinement failure status based at least in part on a failure of a plurality of attempts to refine at least one directional beam to a threshold beam level.

Aspect 14: The method of any of aspects 1 through 11, wherein the first refinement status or the second refinement status, or both, comprises a refinement timeout status based at least in part on duration for refining at least one directional beam exceeding a threshold duration.

Aspect 15: The method of any of aspects 1 through 14, wherein the first refinement status or the second refinement status, or both, comprises a refinement success status based at least in part on refining one or more directional beams to a threshold beam level.

Aspect 16: The method of any of aspects 1 through 15, wherein the first power metric comprises a first reference signal received power and the second power metric comprises a second reference signal received power.

Aspect 17: The method of any of aspects 1 through 16, wherein the first set of synchronization signal blocks comprises a set of serving synchronization signal blocks and the second set of synchronization signal blocks comprises a set of neighboring synchronization signal blocks.

Aspect 18: An apparatus for wireless communication at a UE, comprising a processor; memory coupled with the processor; and instructions stored in the memory and executable by the processor to cause the apparatus to perform a method of any of aspects 1 through 17.

Aspect 19: An apparatus for wireless communication at a UE, comprising at least one means for performing a method of any of aspects 1 through 17.

Aspect 20: A non-transitory computer-readable medium storing code for wireless communication at a UE, the code comprising instructions executable by a processor to perform a method of any of aspects 1 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, wherein a first refinement status for the first set of synchronization signal blocks and a second refinement status for the second set of synchronization signal blocks are based at least in part on the respective beam refinement procedures;
performing measurements of the first set of synchronization signal blocks and the second set of synchronization signal blocks, wherein a first power metric for the first set of synchronization signal blocks and a second power metric for the second set of synchronization signal blocks are based at least in part on the measurements; and
transmitting a message indicating channel state feedback comprising the first power metric or both the first power metric and the second power metric, wherein the channel state feedback comprises both the first power metric and the second power metric based at least in part on the first refinement status and the second refinement status or based at least in part on the second power metric satisfying a threshold.

2. The method of claim 1, further comprising:
determining that a first readiness indicator for the first set of synchronization signal blocks is true based at least in part on the first refinement status for the first set of synchronization signal blocks; and
determining that a second readiness indicator for the second set of synchronization signal blocks is true based at least in part on the second refinement status for the second set of synchronization signal blocks, wherein the channel state feedback comprises both the first power metric and the second power metric based at least in part on the first readiness indicator and the second readiness indicator being true.

3. The method of claim 2, wherein:
the first readiness indicator is true based at least in part on the first refinement status for the first set of synchronization signal blocks comprising a refinement concluded status; and
the second readiness indicator is true based at least in part on the second refinement status for the second set of synchronization signal blocks comprising the refinement concluded status.

4. The method of claim 3, wherein the refinement concluded status is associated with a refinement failure status, or a refinement timeout status, or a refinement success status.

5. The method of claim 1, further comprising:
determining that a first readiness indicator for the first set of synchronization signal blocks is true based at least in part on the first refinement status for the first set of synchronization signal blocks; and
determining that the second power metric satisfies the threshold, wherein the channel state feedback comprises both the first power metric and the second power metric based at least in part on the first readiness indicator for the first set of synchronization signal blocks being true and the second power metric satisfying the threshold.

6. The method of claim 5, wherein the threshold comprises a sum of the first power metric and a hysteresis value.

7. The method of claim 6, further comprising:
generating the hysteresis value based at least in part on whether channel state feedback for the second set of synchronization signal blocks has been previously reported.

8. The method of claim 7, further comprising:
decreasing the hysteresis value based at least in part on previously reporting the channel state feedback for the second set of synchronization signal blocks.

9. The method of claim 7, further comprising:
increasing the hysteresis value based at least in part on the channel state feedback for the second set of synchronization signal blocks being excluded from previous reporting.

10. The method of claim 1, further comprising:
receiving a control message indicating a configuration for performing the measurements of the first set of synchronization signal blocks and the second set of synchronization signal blocks, wherein the configuration indicates a first quantity of measurement occasions that satisfy a threshold quantity of measurement occasions, the first quantity of measurement occasions being based at least in part on the UE operating in a discontinuous reception mode and the first refinement status or the second refinement status, or both.

11. The method of claim 1, further comprising:
determining that a readiness indicator for the second set of synchronization signal blocks is false based at least in part on the second refinement status; and
determining that the second power metric fails to satisfy the threshold, wherein the channel state feedback comprises the first power metric based at least in part on the readiness indicator for the second set of synchronization signal blocks being false and the second power metric failing to satisfy the threshold.

12. The method of claim 1, wherein the first refinement status or the second refinement status, or both, comprises an in-progress refinement status based at least in part on one or more directional beams being at a beam level that is less than a threshold beam level.

13. The method of claim 1, wherein the first refinement status or the second refinement status, or both, comprises a refinement failure status based at least in part on a failure of a plurality of attempts to refine at least one directional beam to a threshold beam level.

14. The method of claim 1, wherein the first refinement status or the second refinement status, or both, comprises a refinement timeout status based at least in part on duration for refining at least one directional beam exceeding a threshold duration.

15. The method of claim 1, wherein the first refinement status or the second refinement status, or both, comprises a refinement success status based at least in part on refining one or more directional beams to a threshold beam level.

16. The method of claim 1, wherein the first power metric comprises a first reference signal received power and the second power metric comprises a second reference signal received power.

17. The method of claim 1, wherein the first set of synchronization signal blocks comprises a set of serving synchronization signal blocks and the second set of synchronization signal blocks comprises a set of neighboring synchronization signal blocks.

18. An apparatus for wireless communication at a user equipment (UE), comprising:
a processor;
memory coupled with the processor; and
instructions stored in the memory and executable by the processor to cause the apparatus to:
perform respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, wherein a first refinement status for the first set of synchronization signal blocks and a second refinement status for the second set of synchronization signal blocks are based at least in part on the respective beam refinement procedures;
perform measurements of the first set of synchronization signal blocks and the second set of synchronization signal blocks, wherein a first power metric for the first set of synchronization signal blocks and a second power metric for the second set of synchronization signal blocks are based at least in part on the measurements; and
transmit a message indicating channel state feedback comprising the first power metric or both the first power metric and the second power metric, wherein the channel state feedback comprises both the first power metric and the second power metric based at least in part on the first refinement status and the second refinement status or based at least in part on the second power metric satisfying a threshold.

19. The apparatus of claim 18, wherein the instructions are further executable by the processor to cause the apparatus to:
determine that a first readiness indicator for the first set of synchronization signal blocks is true based at least in part on the first refinement status for the first set of synchronization signal blocks; and
determine that a second readiness indicator for the second set of synchronization signal blocks is true based at least in part on the second refinement status for the second set of synchronization signal blocks, wherein the channel state feedback comprises both the first power metric and the second power metric based at least in part on the first readiness indicator and the second readiness indicator being true.

20. The apparatus of claim 19, wherein:
the first readiness indicator is true based at least in part on the first refinement status for the first set of synchronization signal blocks comprising a refinement concluded status; and
the second readiness indicator is true based at least in part on the second refinement status for the second set of synchronization signal blocks comprising the refinement concluded status.

21. The apparatus of claim 20, wherein the refinement concluded status is associated with a refinement failure status, or a refinement timeout status, or a refinement success status.

22. The apparatus of claim 18, wherein the instructions are further executable by the processor to cause the apparatus to:
determine that a first readiness indicator for the first set of synchronization signal blocks is true based at least in part on the first refinement status for the first set of synchronization signal blocks; and
determine that the second power metric satisfies the threshold, wherein the channel state feedback comprises both the first power metric and the second power metric based at least in part on the first readiness indicator being true and the second power metric satisfying the threshold.

23. The apparatus of claim 22, wherein the threshold comprises a sum of the first power metric and a hysteresis value.

24. The apparatus of claim 23, wherein the instructions are further executable by the processor to cause the apparatus to:
generate the hysteresis value based at least in part on whether channel state feedback for the second set of synchronization signal blocks has been previously reported.

25. The apparatus of claim 24, wherein the instructions are further executable by the processor to cause the apparatus to:
decrease the hysteresis value based at least in part on previously reporting the channel state feedback for the second set of synchronization signal blocks.

26. The apparatus of claim 24, wherein the instructions are further executable by the processor to cause the apparatus to:
increase the hysteresis value based at least in part on the channel state feedback for the second set of synchronization signal blocks being excluded from previous reporting.

27. The apparatus of claim 18, wherein the instructions are further executable by the processor to cause the apparatus to:
receive a control message indicating a configuration for performing the measurements of the first set of synchronization signal blocks and the second set of synchronization signal blocks, wherein the configuration indicates a first quantity of measurement occasions that satisfy a threshold quantity of measurement occasions, the first quantity of measurement occasions being based at least in part on the UE operating in a discontinuous reception mode and the first refinement status or the second refinement status, or both.

28. The apparatus of claim 18, wherein the instructions are further executable by the processor to cause the apparatus to:
determine that a readiness indicator for the second set of synchronization signal blocks is false based at least in part on the second refinement status; and
determine that the second power metric fails to satisfy the threshold, wherein the channel state feedback comprises the first power metric based at least in part on the readiness indicator being false and the second power metric failing to satisfy the threshold.

29. An apparatus for wireless communication at a user equipment (UE), comprising:
means for performing respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, wherein a first refinement status for the first set of synchronization signal blocks and a second refinement status for the second set of synchronization signal blocks are based at least in part on the respective beam refinement procedures;
means for performing measurements of the first set of synchronization signal blocks and the second set of synchronization signal blocks, wherein a first power metric for the first set of synchronization signal blocks and a second power metric for the second set of synchronization signal blocks are based at least in part on the measurements; and
means for transmitting a message indicating channel state feedback comprising the first power metric or both the first power metric and the second power metric, wherein the channel state feedback comprises both the first power metric and the second power metric based at least in part on the first refinement status and the second refinement status or based at least in part on the second power metric satisfying a threshold.

30. A non-transitory computer-readable medium storing code for wireless communication at a user equipment (UE), the code comprising instructions executable by a processor to:
perform respective beam refinement procedures for a first set of directional beams and a second set of directional beams, the first set of directional beams corresponding to a first set of synchronization signal blocks of a serving cell and the second set of directional beams corresponding to a second set of synchronization signal blocks of the serving cell, wherein a first refinement status for the first set of synchronization signal blocks and a second refinement status for the second set of synchronization signal blocks are based at least in part on the respective beam refinement procedures;
perform measurements of the first set of synchronization signal blocks and the second set of synchronization signal blocks, wherein a first power metric for the first set of synchronization signal blocks and a second power metric for the second set of synchronization signal blocks are based at least in part on the measurements; and
transmit a message indicating channel state feedback comprising the first power metric or both the first power metric and the second power metric, wherein the channel state feedback comprises both the first power metric and the second power metric based at least in part on the first refinement status and the second refinement status or based at least in part on the second power metric satisfying a threshold.
